(19) United States
(12) Patent Application Publication
(10) Pub. No.: US 2013/0309014 A1
(43) Pub. Date: Nov. 21, 2013

(54) Method and apparatus for removing seaweed from a beach

(71) Applicants: Jonathan K.W. Biley, Surrey (CA); Gary Oh, Surrey (CA)

(72) Inventors: Jonathan K.W. Biley, Surrey (CA); Gary Oh, Surrey (CA)

(21) Appl. No.: 13/573,792

(22) Filed: Oct. 3, 2012

Related U.S. Application Data
(60) Provisional application No. 61/697,293, filed on Sep. 6, 2012.

(30) Foreign Application Priority Data
Nov. 17, 2011 (CA) 2758915

(51) Int. Cl. B09C 1/00

(52) U.S. Cl. CPC B09C 1/00
USPC 405/128.25; 405/128.2; 405/128.4

(57) ABSTRACT

A method for removing seaweed from a beach. A first step involves providing a primary vessel with a seaweed collection area and a vacuum source. A second step involves anchoring the primary vessel offshore. A third step involves connecting one end of a vacuum hose to the vacuum source and extending a remote end of the vacuum hose to the beach. A fourth step involves controlling the positioning of the remote end of the vacuum hose along the beach with a secondary vessel that is small in relation to the primary vessel. A fifth step involves activating the vacuum and feeding seaweed into the remote end of the vacuum hose. The seaweed is drawn by the vacuum source through the vacuum hose to the seaweed collection area on the primary vessel.

### FIELD

There is described a method of removing seaweed from a beach and an apparatus developed in accordance with the teachings of the method.

### BACKGROUND

It is common for seaweed to wash up on a beach. When this occurs the rotting seaweed serves as an obstacle, serves as a breeding ground for insects, is the source of an unpleasant odours and generally interferes with the use and enjoyment of the beach. Some prominent beaches are fortunate enough to have taxpayer funded seaweed removal, most beaches are not so fortunate and no active steps are taken to remove the seaweed from the beach. Some types of seaweed have commercial value which serves as an incentive for commercial interests to engage in privately funded seaweed removal, most seaweed does not have significant commercial value and is of little commercial interest.

Removing seaweed from a beach currently involves driving a collection vehicle along the beach and manually placing the seaweed into the collection vehicle. Unfortunately, residents often find that the operation of the collection vehicle along their beach interferes with their use and enjoyment just as much or more than the accumulation of seaweed. The prior art of harvesting beached seaweed include horse drawn nets through the surf, the use of pitch forks and wheel barrows, and ATV's towing trailers. All of these methods have a relatively low rate of productivity and often damage the beach with tracks and depressions. What is required is a less intrusive method of removing seaweed from a beach.

### SUMMARY

According to one aspect there is provided a method for removing seaweed from a beach. A first step involves providing a primary vessel with a seaweed collection area and a vacuum source. A second step involves anchoring the primary vessel offshore. A third step involves connecting one end of a vacuum hose to the vacuum source and extending a remote end of the vacuum hose to the beach. A fourth step involves controlling the positioning of the remote end of the vacuum hose along the beach with a secondary vessel that is small in relation to the primary vessel. A fifth step involves activating the vacuum and feeding seaweed into the remote end of the vacuum hose. The seaweed is drawn by the vacuum source through the vacuum hose to the seaweed collection area on the primary vessel.

The method described above enables seaweed to be collected efficiently, with minimal disturbance to the beach.

Although beneficial results may be obtained through the use of the method described above, seaweed has a very high water content. It is, therefore, preferred that some preliminary processing in situ on the primary vessel.

One important processing step is washing the seaweed with salt water to remove contaminants before depositing the seaweed into the seaweed collection area. It is preferred that the salt water be drawn from the body of water that the primary vessel is floating upon.

Another important processing step is removing water from the seaweed before depositing the seaweed in the seaweed collection area. The seaweed is dehydrated until the water content of the seaweed is within selected limits.

According to another aspect there is provided an apparatus for removing seaweed from a beach. The apparatus includes in combination a primary vessel with a collection area and a vacuum source positioned on the primary vessel configured to discharge into the collection area. A vacuum hose is provided having a first end connected to the vacuum and a remote end. a secondary vessel is provided that is small in relation to the primary vessel and coupled to the vacuum hose to control the remote end of the vacuum hose. A seaweed receiver is configured to be positioned on the beach and connected to the second end of the vacuum hose.

Even more beneficial results may be obtained when the primary vessel has a seaweed conditioning area with a seaweed washer. It is preferred that the seaweed washer is configured to wash the seaweed using salt water drawn from a body of water that the primary vessel is floating upon.

Even more beneficial results may be obtained when the primary vessel has a seaweed conditioning area with a seaweed dryer. It is preferred that the seaweed dryer uses waste heat from the vacuum source.

Even more beneficial results may be obtained when the vacuum hose has a first length of hose of a first diameter which floats on water and a second length of hose of a relatively smaller second diameter which is easier for shore staff to handle.

Even more beneficial results may be obtained when a first seaweed metering station receives seaweed from the vacuum and controls a flow of seaweed along a first conveyor to the seaweed washer.

Even more beneficial results may be obtained when a second seaweed metering station receives seaweed from the seaweed washer and controls a flow of seaweed along a second conveyor to the seaweed dryer.

Even more beneficial results may be obtained when a sound barrier is provided to deflect sound from the vacuum source away from the beach.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIGS. 1a and 1b when viewed together provide a top plan view of a first embodiment of apparatus for removing seaweed from a beach.

FIGS. 2a and 2b when viewed together provide a side elevation view of the first embodiment of apparatus for removing seaweed from a beach illustrated in FIGS. 1a and 1b.

FIG. 3 is a top plan view of a second embodiment of apparatus for removing seaweed from a beach.

FIG. 4 is a side elevation view of the second embodiment of apparatus for removing seaweed from a beach illustrated in FIG. 3.

FIG. 5 is a top plan view of a third embodiment of apparatus for removing seaweed from a beach.

FIG. 6 is a side elevation view of the third embodiment of apparatus for removing seaweed from a beach illustrated in FIG. 5.

FIG. 7 is a top plan view of a first embodiment of seaweed receiver.

FIG. 8 is a side elevation view, in section, of the first embodiment of seaweed receiver illustrated in FIG. 7.

FIG. 9 is an end elevation view of a first embodiment of cylindrical buoy, shown in an open position.

FIG. 10 is a top plan view of the first embodiment of cylindrical buoy illustrated in FIG. 9.

FIG. 11 is a top plan view of a fourth embodiment of apparatus for removing seaweed from a beach.

FIG. 12 is a top plan view, in partial section, of the fourth embodiment of apparatus for removing seaweed from a beach illustrated in FIG. 11.

FIG. 13 is a top plan view, in partial section, of a dehumidifier.

FIG. 14 is a top plan view of a second embodiment of seaweed receiver.

FIG. 15 is a side elevation view, in section, of the second embodiment of seaweed receiver illustrated in FIG. 14.

FIG. 16 is a top plan view of the second embodiment of seaweed receiver illustrated in FIG. 14, showing deployment on a beach.

### DETAILED DESCRIPTION

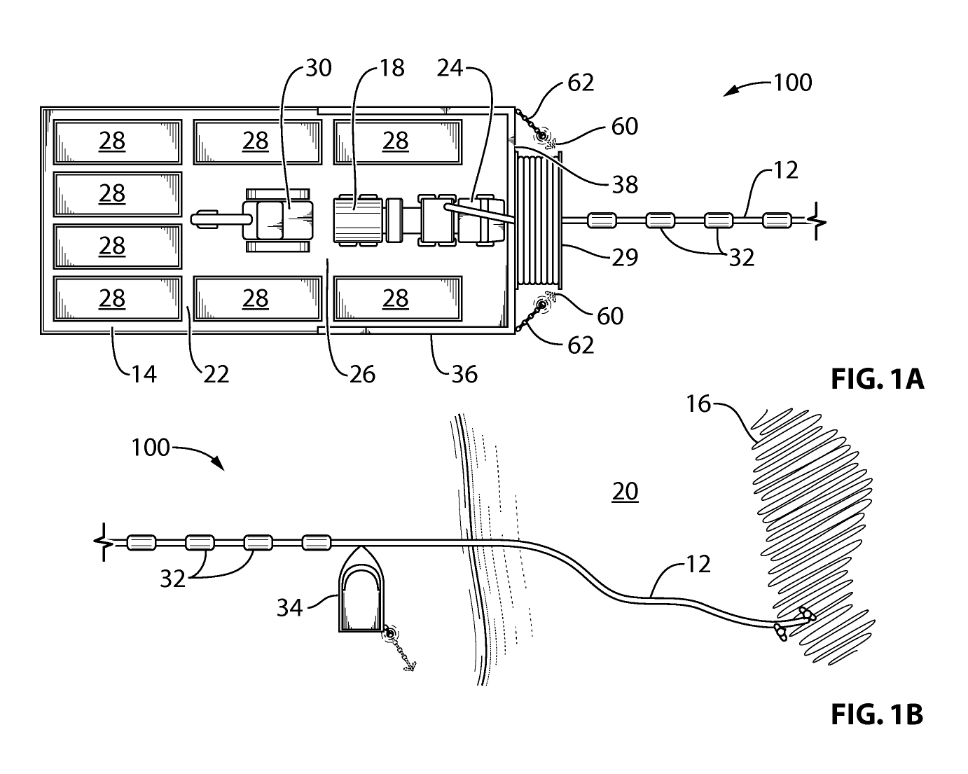

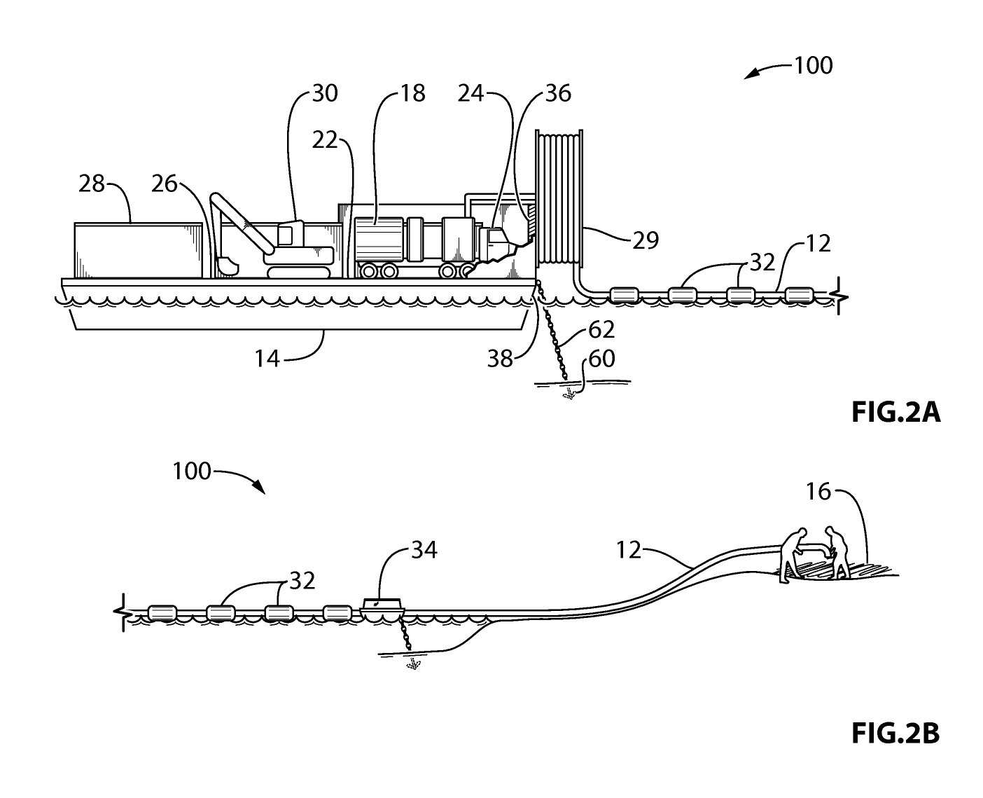

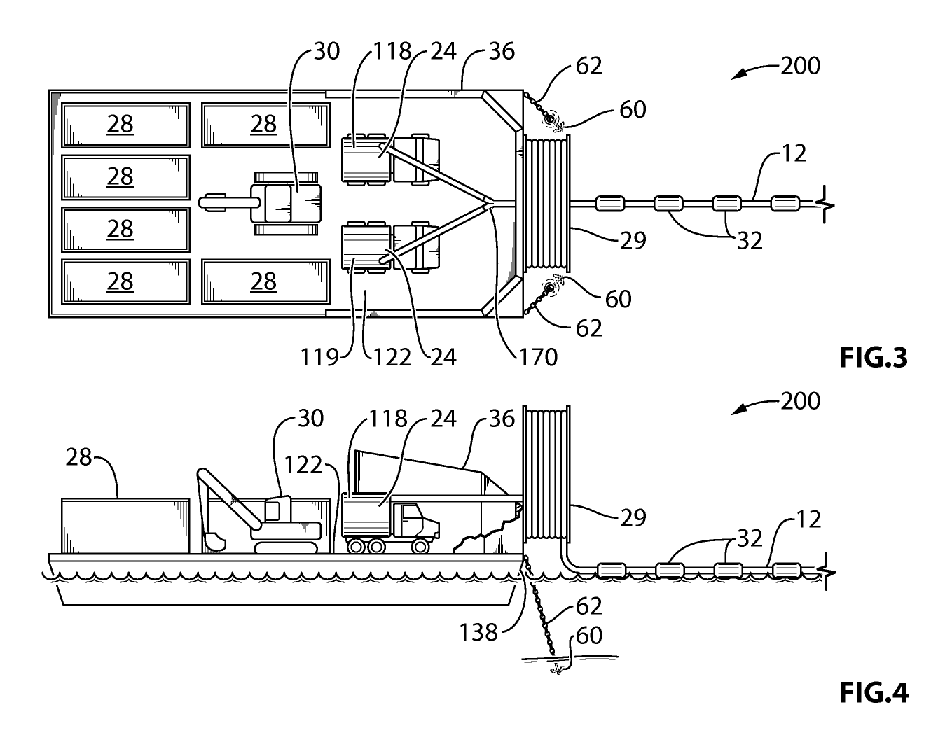

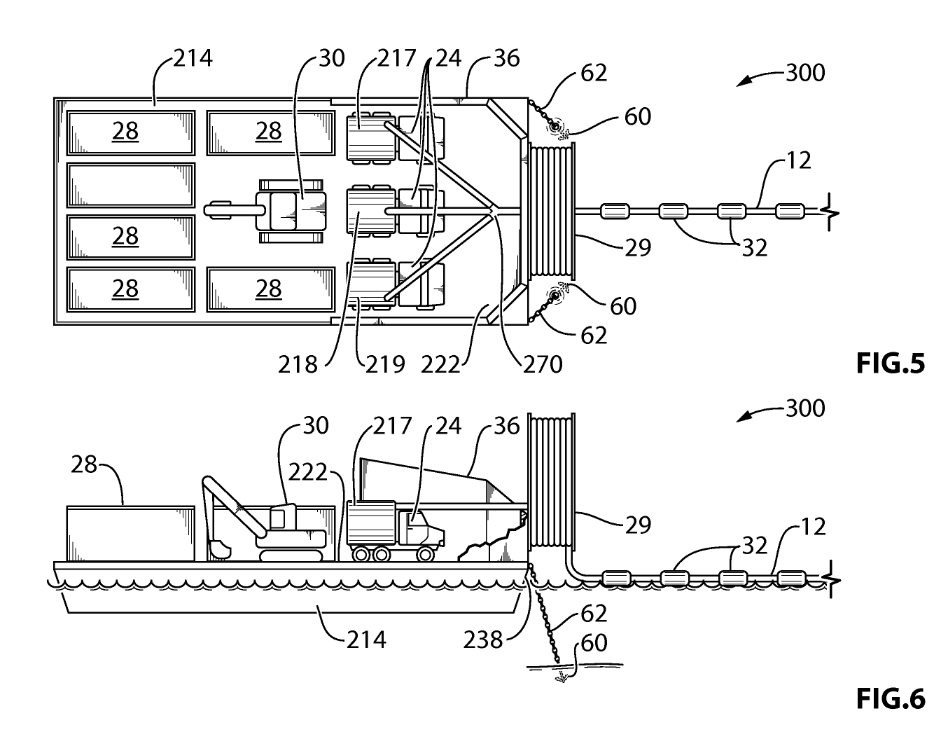

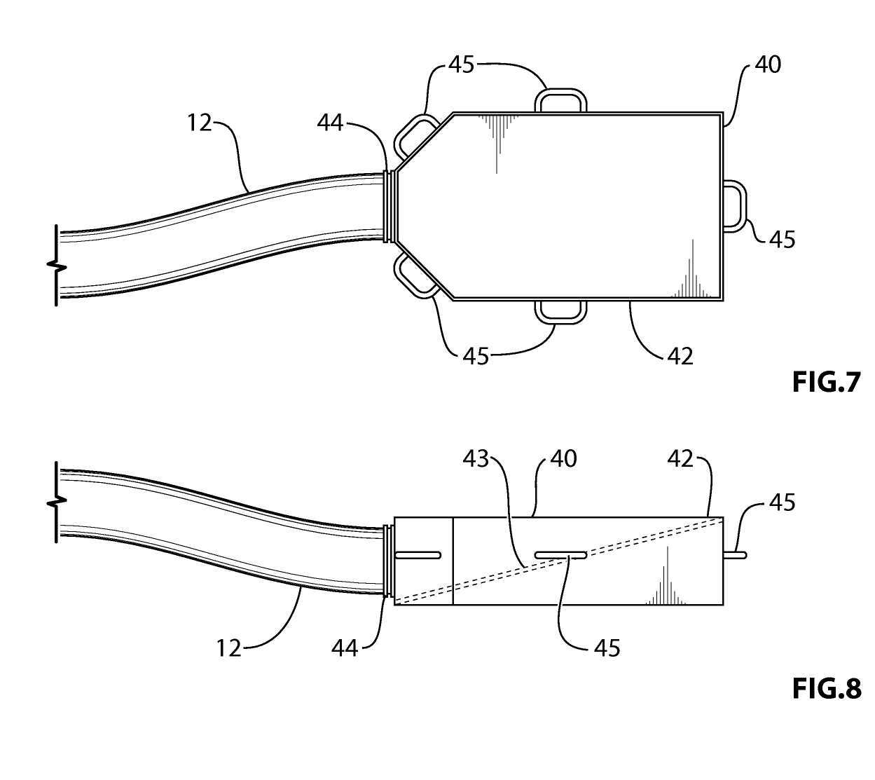

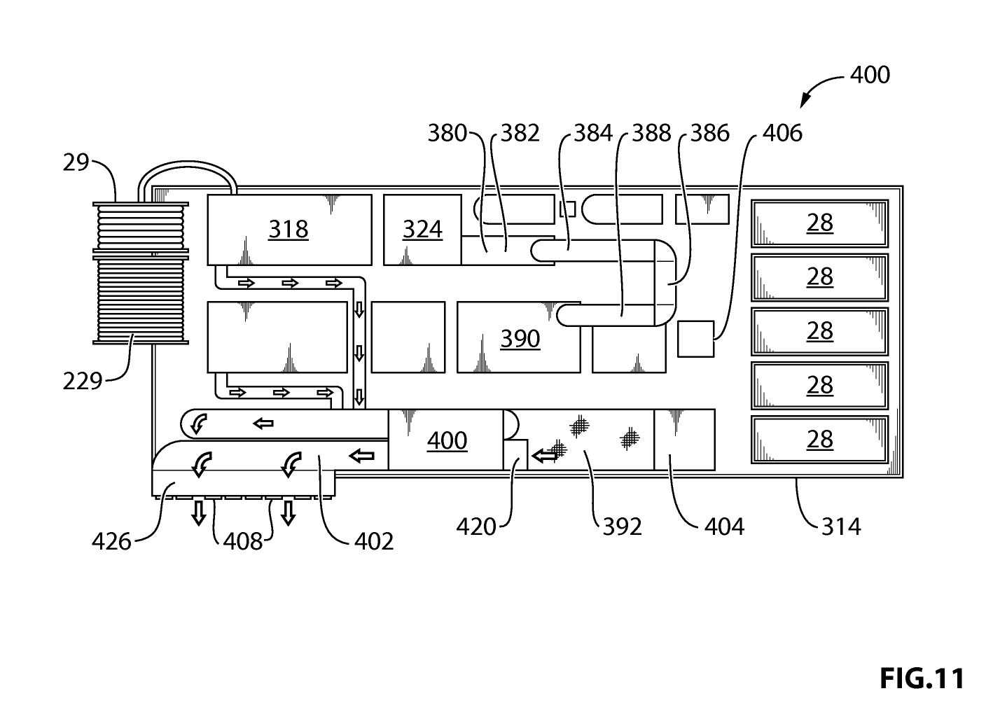

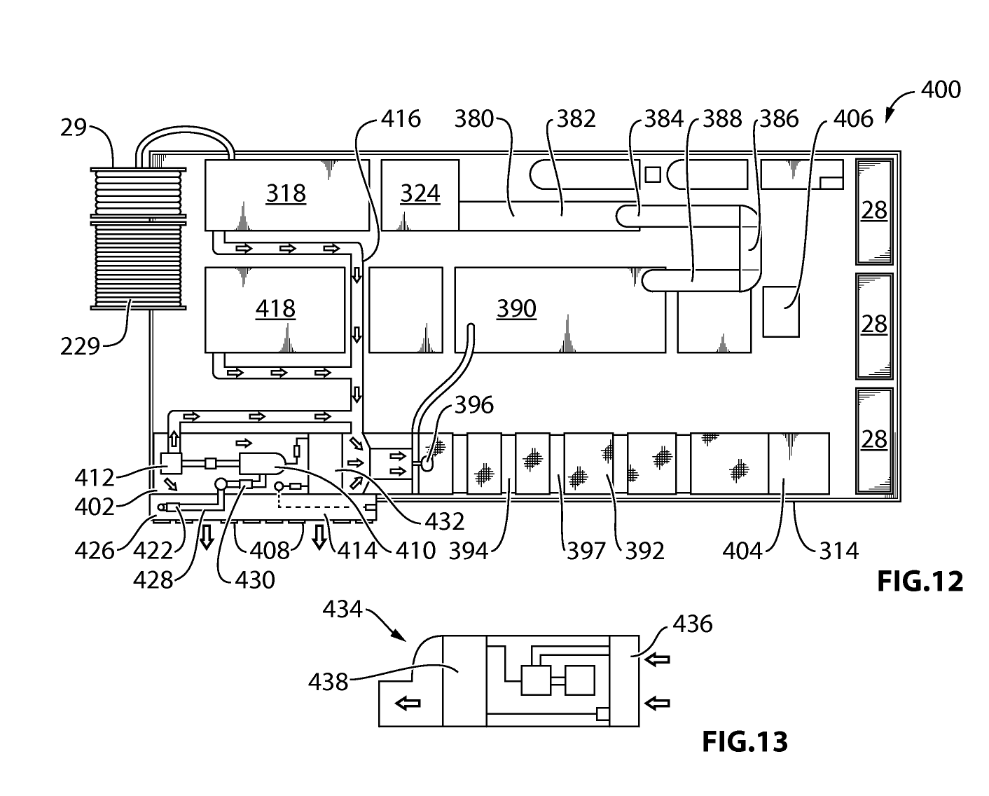

An apparatus for removing seaweed from a beach will now be described with reference to FIG. 1 through 16. There are several alternative embodiments of the apparatus. A first embodiment 100 will be described with reference to FIGS. 1a, 1b, 2a and 2b. A second embodiment 200 will be described with reference to FIGS. 3 and 4. A third embodiment 300 will be described with reference to FIGS. 5 and 6. Components that can be used in conjunction with any of the embodiments will be described with reference to FIG. 7 through 10. A fourth embodiment 400 will be described with reference to FIGS. 11 and 12. Components of fourth embodiments 400 will be described with reference to FIG. 13 through 18.

### Structure and Relationship of Parts:

Referring to FIGS. 1a, 1b, 2a, and 2b first embodiment 100 will be described. In this description, only the features of the invention which relate to the harvest of the beached seaweed are mentioned, as the other parts of the vessel will be readily understood by those skilled in the art.

A hose 12 of polyvinyl chloride or other flexible material is deployed from a primary vessel 14 that is several hundred feet to a thousand foot or greater distance away from the seaweed deposit 16. This hose of 4 inches to 12 inches or greater allows transportation of the seaweed via vacuum source 18 off the beach 20. It does not damage the beach 20 as mechanized vehicles or horses would, and this method has a proven harvest rate of 100 kilograms per minute or more with chondrus type seaweed.

Referring to FIGS. 3 and 4, the second embodiment uses parallel vacuum sources 118 and 119 which allows transportation of the seaweed 16 from the beach 20 to very large distances of up to a thousand feet or more. This has a distinct advantage over a single vacuum source from a vacuum excavator truck, which maintains a good flow at only 500 feet with a 6″ hose. This is not long enough a hose to effectively access many shallow areas.

FIGS. 1a, 1b, 2a and 2b is of the primary vessel 14. In this first embodiment, the vacuum source 18 positioned on a deck 22 of the primary vessel 14 is a vacuum excavator truck 24. A seaweed collection and handling area 26 is provided which includes shipping containers 28, and a small front end loader 30. It also depicts full deployment of the hose 12 with buoys 32 attached and the hose 12 being manoeuvred by personnel on the beach 20, while the hose 12 is stabilized by a small craft 34 in shallow waters against currents and tides. The hose 12 has also been anchored in its center for additional support against currents. The figures also depict a flat sound reflecting wall 36 mounted on the bow 38 of the primary vessel 14 and at a height greater than the truck 24, to deflect sound away from the beach 20. Primary vessel 14 may be anchored in a position where it will not beach during lowering tides using anchors 60 and rope 62. Although two sets of anchors 60 and rope 62 are shown in the embodiments provided, it will be understood that a single anchor 60 and rope 62 or additional anchors 60 and ropes 62 may be used to maintain the positioning of primary vessel 14. The primary vessel 14 is also equipped with a large spool 29 mounted on the sound reflector 36 or a mount on the bow 38. The hose 12 is wound around the spool 29 when not in use.

Once the hose 12 is fully deployed, the small craft operator may attach anchors 60 and rope 62 to the hose 12 to maintain the hose's position. The small craft operator then moves his small craft 34 into the shallow water and as close to shore as possible, and attaches the small craft 34 to the hose 12 by rope or other fastener. He can either anchor his small craft 34 or he uses the force of his engine to maintain position. Two or three beach personnel manoeuver the hose 12 over the seaweed pile 16 and the vacuum source 18 commences with suction. The personnel on the beach 20 then move the hose 12 over the seaweed piles 16 from side to side, causing the seaweed to be sucked into the hose 12 and flow to the vacuum excavator truck 24 on the primary vessel 14. As the beach crew will have in many cases at least 200 feet or more of slack in the hose 12, the crew is able to harvest a total amount of beach of approximately 400 or more feet operating in both directions. The seaweed 16 flows freely through the hose 12 and to one or more vacuum excavation trucks 24, filling holding tank(s). This continues until the truck's tank is full.

FIGS. 3 and 4 is a variation of the primary vessel 114, with the deck 122 comprised of two parallel mounted and connected vacuum sources 118 and 119 and vacuum excavator trucks 24, shipping containers 28, a front end loader 30, and a parabolic sound reflector 136 mounted on the bow 138 which surrounds the vacuum sources 118 and 119 and vacuum excavator trucks 24, reflecting sound towards the stern in an upward direction.

FIGS. 7 and 8 is a seaweed receiver 40 consisting of a hopper 42 which is attached to the remote end 44 of the hose 12 used when seaweed is to be fed in by hand. Referring to FIG. 8, the seaweed receiver 40 has a sloped bottom 43 which slopes towards the hose 12 to help prevent the seaweed from simply sitting in the hopper 42 without moving through the hose 12. Handles 45 are provided on the seaweed receiver 40 to provide handholds for personnel moving the seaweed receiver 40 during use.

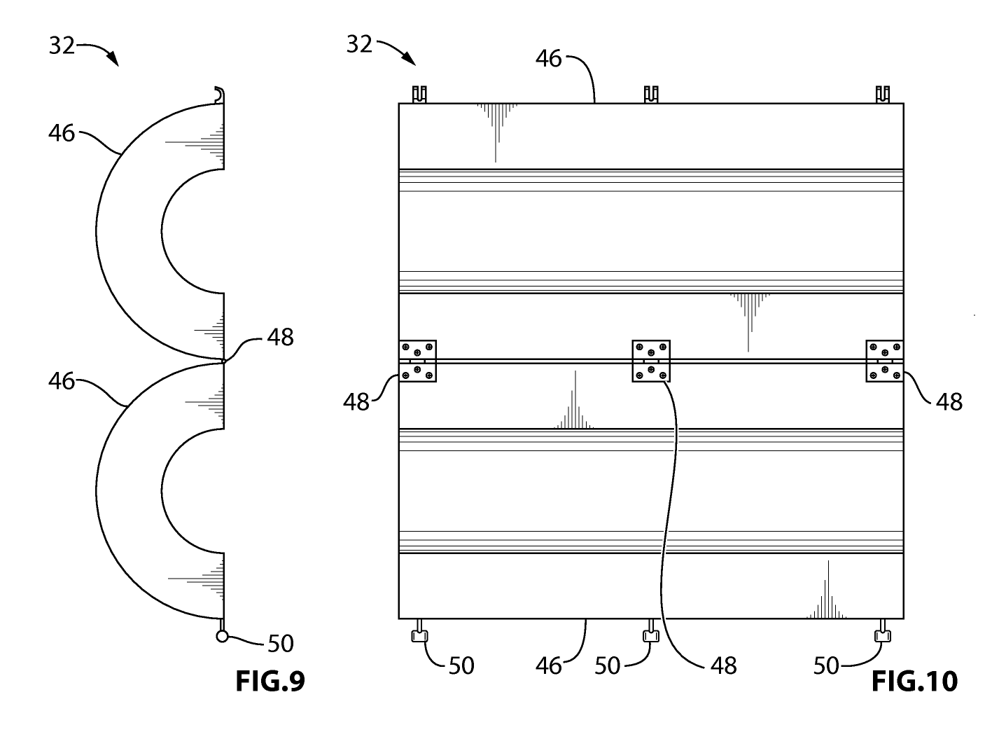

FIGS. 9 and 10 is a cylindrical “0” type buoy 32 that is designed to be attached to the suction hose 12, comprised of two C halves 46 connected by hinges 48. On the opposite end of the hinges is a locking clamp 50 to secure the buoy to the hose 12. The inside of the locked “0” type buoy 32 is equivalent to the outside diameter of the polyvinyl chloride hose 12. The buoy 32 can be composed of a variety of materials, such as foam or rubber.

FIGS. 5 and 6 is a variation of the primary vessel 214, with the deck 222 comprised of three parallel mounted vacuum sources 217, 218 and 219, with corresponding excavator trucks 24 and shipping containers 28.

Referring to FIG. 3 or 5, two or more vacuum sources 118 and 119 or 217, 218 and 219 on the vessel 114, 214 are connected in parallel, to increase the effective harvest range. Referring to FIG. 3, an adapter 170 shaped as a Y and composed of either plastic or metal, is used to join two vacuum sources 118 and 119 to one suction hose 112, or, referring to FIG. 5, a curved manifold 270 is used to join multiple vacuum sources 217, 218 and 219 of three or more.

In the first embodiment, the primary vessel 14 is towed by a tug boat, not shown. However, in one variation the primary vessel 14 could be self-propelled as a LCM (Landing Craft Military)

In one variation, the vacuum sources 18, 118 and 119 or 217, 218 and 219 and tank(s) on excavator truck 24 are independent of any vehicle and are mounted directly to the primary vessel 14, 114 or 214.

The tank of the vacuum excavator 24 is then emptied onto the deck 22, 122 or 222 of the primary vessel 14, 114 or 214, where the compressed seaweed 16 is transferred into the shipping containers 28 by means of a small front end loader 30. The vacuum excavator 24 and personnel continue with harvest operations until the tank of the excavator truck 24 is full again and then repeat the transfer process.

After the labourers have harvested all permitted seaweed 16 that is within reach of the hose 12, the small craft operator will detach and retrieve any rope 62 and anchors 60. The primary vessel 14, 114 or 214 will raise its anchors 60. Then the primary vessel 14, 114 or 214, small craft 34, and beach personnel reposition the vessel 14, 114 or 214, the small craft 34 and hose 12 in sync and in a parallel direction, so that a new session of harvest can take place. A sound reflecting wall 36 at least 6″ in thickness and which can be composed of a variety of materials, reflects the majority of the sound from the vacuum excavator 24 out to sea and in a rearward direction. In one variation of the invention, the sound reflecting wall 36 is simply flat, covering the bow 38, 138 or 238 and at a height greater than that of the vacuum excavator 24, with 90 degree angled walls extending down port and stem much like three sides of a box.

Referring to FIGS. 3 and 4, the sound reflecting wall 36 is shaped as an upward focused parabolic reflector, so that the majority of sound is reflected opposite from shore and in a slightly upward direction.

By way of example for the use, on Vancouver Island, British Columbia, an estimated 50,000 metric tons of the seaweed mazzaella japonica washes up on beaches near the Deep Bay/Qualicum region each year, often as high as a meter deep and 8 meters wide. This seaweed is high in carrageenan, which is a thickener, gelling agent, and stabilizer, and has significant commercial value in the food industry. As land access is difficult, this method of harvest is ideal for a commercial scale harvest of the aforementioned seaweed.

Deep Bay has many shallow areas where a large barge would not be able to access during low tide with only 500 feet of hose. The barge would bottom out and possibly damage clam beds and other sea life or ecology. By operating multiple vacuum sources on the harvest vessel and a small craft in the shallows, we are able to operate in shallower depths and at greater distances.

Referring to FIGS. 11 and 12, there is illustrated a fourth embodiment 400. Fourth embodiment has added capacity to process the seaweed 16 including cleaning and drying.

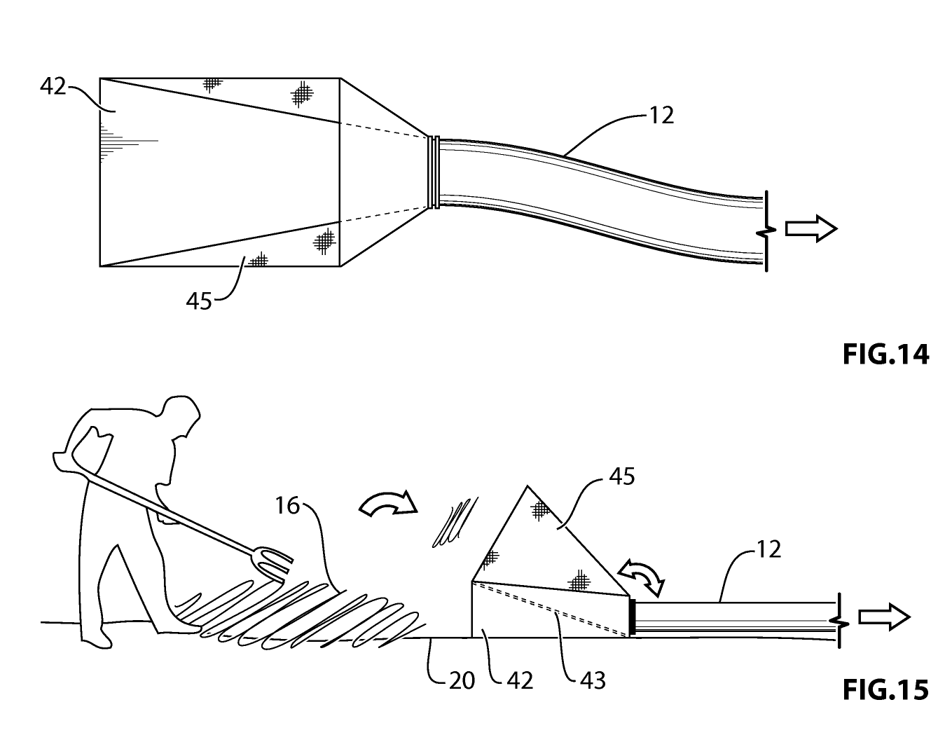

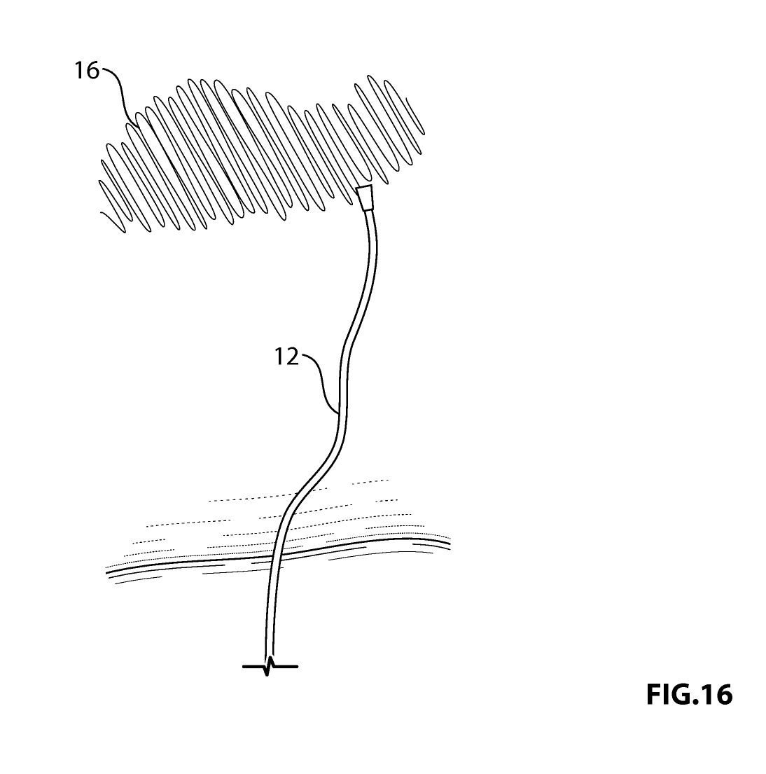

The primary vessel 314 is first deployed near a deposit of beached seaweed. This seaweed is generally deposited naturally in a form called a windrow, which may only be 10 meters wide but can extend for great distances along the tide line. The primary vessel 314 anchors itself in enough water to not bottom out, but also to anchor the primary vessel 314 as close to shore as possible. As described above, a small craft 34 first deploys the floating hose 12 in its entirety from the spool 29 depicted. The amount of floating hose 12 will be approximately 300′ but will be varied by the operator depending on underwater slope and terrain of the harvest area. The small craft operator then deploys the lighter hose, but only enough to commence operations based on the tide level. The lighter hose on spool 229 attaches to the floating hose by way of a locking connector, not shown. Referring to FIG. 16, the hose is deployed in a C configuration. This allows beach workers the ability to move less hose during the course of harvest operations. Referring to FIGS. 14 and 15, a hopper 42 bordered by a hockey net 45 is moved in a right-to-left direction in the example as piles are harvested.

The seaweed is first pitchforked or otherwise loaded into the hockey net 45, where it falls by force of gravity, vacuum, and inertia from the workers pitchfork into a roughly 7″ vacuum hose 12 but varying in size, where it is sucked through first light and flexible hose, but then to heavier floating hose, and to a vacuum excavator unit 24, or any other suitable vacuum source 318.

A vacuum source 318, in this example is a vacuum unit equipped with four turbines, where only two need be operated during high tide harvest with shorter hose length to save on fuel, while all four turbines can be run during low tide operations with longer overall hose lengths.

The vacuum source 318 has a storage tank on the back of the unit. When the storage tank holding the seaweed becomes full, it is dumped similar to a dump truck into a dumping bin 324, where it is evenly carried up a conveyor 380 and onto a level conveyor surface 382, where workers .under bright full spectrum light are able to pick out immediate and noticeable impurities, such as competing brown or green seaweeds. The conveyor then flows in an upward direction to the top of a trommel washer 384.

A trommel washer 384 is a sloped cylinder with perforations, which is well known in the prior art for cleaning all sorts of vegetation, where the vegetation topples over itself in a rotating cylinder, while a stream of salt water is passed over the seaweed. Salt water is preferred for this process, since it does not leach carrageenan out of the seaweed and may be filtered from sea water before it reaches the trommel.

The seaweed which is now cleaner in terms of rocks, sand, crustaceans, shells, and the like, is also saturated with water. The seaweed then flows from the bottom exit of the trommel washer up a conveyor 386 making either a 90 degree or 180 degree turn, into another perforated sloped cylinder known as an automatic vegetable centrifuge 388, which is closed at the bottom by a door and the feed conveyor operates until the cylinder is full, where it then stopped by a worker control or automation, and the top door to the cylinder is sealed. The seaweed is spun in the cylinder around at a high rate of speed until water is no longer being efficiently removed and drained. This has the effect of efficiently reducing the water content of the seaweed by about 20%.The bottom door is now opened by automation, which causes the seaweed to dump into a metering bin 390 by way of gravity.

Referring to FIG. 12, the metering bin 390 is designed to work in conjunction with the mesh belt dryer 392, and is very common in the prior art, where an even layer of seaweed is distributed onto a small conveyor 394 and then a spreader 396. Stirators 397 rotate the seaweed over with multiple blades, so as to cause the wet bottom to overturn onto the top, causing a more even drying throughout.

The harvest operations are likely to occur faster than the dryer 392 can process the seaweed, so the metering bin 390 allows approximately 60 tons of wet seaweed to accumulate, so that the dryer 392 may run during transport of the vessel 314 or during times when the harvest crew are not harvesting.

As the seaweed is passed down the conveyor belt 394 flowing to the stem of the ship, an ideally 40 degree Celsius volume of air approximately 100,000 cubic feet a minute is forced through a long layer of seaweed approximately 16″ deep, where, referring to FIG. 11, moisture is carried away from the layer through the exhaust. The humid exhaust is recycled into the system by first passing through an air-to-air exchanger 400 where incoming air is heated from the exhaust air, and then the exhaust air moves into the heat pump system 402 as described later in this document.

The seaweed exits the dryer 392 and falls into a compression baler 404, where a worker controls both a conveyor and a compression bailer, not shown, which are well known instrument to anyone skilled in that art. The bails are loaded onto a pallet, where they are transferred by forklift to a shipping container 28, and stacked in an appropriate manner. The bales may be sealed in plastic to preserve exact moisture content.

There are different ways to load and unload the shipping containers 28 off the barge, but crane 406 is one of the easiest and most useful. A crane 406 on the barge is able to transfer the containers to another vessel, to dock, or to shore.

The dryer 392 begins with the dryer belt 394, fans 408, and compressor beginning operations. The compressor 410 in this example is powered by an internal combustion diesel engine 412, running biodiesel for the sake of direct firing clean exhaust into the drying operation. Referring to FIG. 11, where dirty fuels are being used, air to air heat exchangers 400 can be used to transfer thermal energy.

Referring to FIG. 12, in the present invention the heat energy from the compressor 410, engine 412, the cooling systems 414 and the exhaust 416 from the generator 418 and vacuum source 318, are recycled into the dryer 392 through the air intake 420, shown in FIG. 11 into the dryer 392. Referring to FIG. 11, the compressor 410 must be started at a slow speed and gently increased over a period of time, so as to avoid flooding of refrigerant liquid into the compressor suction, with several safety mechanisms installed to account for refrigerant changes in state and pressure. In the case of multiple compressors, one compressor will start for a short period of time to inject energy into the system, the second compressor will start for a short period of time and run with the first, then three compressors, and so on and so forth until the unit is at full temperature and capacity.

The outside air temperature, temperature of the dryer exhaust, internal temperature, and condenser temperature are all monitored by a thermostat and connected to a control computer, and hygrometer of the air exhaust and air intake as well, also inputted into a computer. The computer can then vary the speed of engine and adjust both the evaporator pressure through the thermal expansion valve and the evaporator pressure regulator as well as the condenser pressure regulator.

Once the desired temperature within the dryer 392 or the system has been reached, product can start to enter the dryer 392 through metering bin 390 and into the dryer 392 by a spreader 396, while the compressor's rate of speed will be controlled by controlling the speed of the engine 412. The speed of the compressor 410 can regulate the recycling of energy and control the internal temperature of the dryer 392. If the temperature becomes too hot inside the system, the compressor 410 will slow in pump speed by means of engine speed or a compressor unloader system, which will have the result of less energy being recycled into the system. If the internal drying temperature becomes too low with the dryer 392, the compressor 410 can run at full speed until the correct internal temperature is achieved.

The ideal internal temperature of the dryer 392 is roughly 40 C and the exhaust to the ait-to-air exchanger 400 is roughly 22 degrees Celsius due to evaporative cooling from the wet seaweed. The evaporator fans 408 vary speed enough to maintain a slightly negative pressure on the top side of the product layer through the dryer 392, as the internal pressure is monitored by a sensor, minimizing energy loss through air convection on the end of dryer 392. Where multiple evaporators 422 are used, their relative fan 408 will shut off when not in use so that air is directed through the units in operation. The humid exhaust air passes through the Evaporator 422 or any other conventional evaporator rated large enough to absorb the thermal energy in the drying operation. Conduction of heat and energy transfer occurs from the high temperature air to the low temperature evaporator refrigerant. The refrigerant ideally ammonia gas, but also Forane, R-22, chloroflourocarbons, hydroflourocarbons, hydrocarbons such as propane, carbon dioxide, or any other form of suitable refrigerant, is injected from the insulated high pressure lines through a thermal expansion valve from an area of moderate to high pressure, to an area of low pressure, thereby creating the Joules-Thompson effect inside the evaporator. The pressure is calibrated by adjustment of the thermal expansion valve and the evaporator pressure regulator, not shown, to not drop the temperature far below 0 degrees Celsius, to prevent freezing of water on the evaporator plates. In many cases the evaporator internal gas temperature may be calibrated to 10 degrees to 15 degrees, to maximize co-efficient of performance and to balance the recycling of energy. Referring to FIG. 11, the warm exhaust air that has exited the air to air exchanger 400 is now passed over the evaporator coils 426.

Referring to FIG. 12, the exit refrigerant gas of the evaporator 422 passes through an evaporator pressure regulator, not shown, where it is controlled by the computer by means of an electronic evaporator pressure regulator, not shown, to maintain the proper pressure in the evaporator coils 426 even during slower compressor speeds, thereby preventing a drop in pressure that may cause the evaporator plates to freeze.

The Joules-Thompson effect lowers the temperature of the gas substantially, where thermal energy transfer occurs from the exhaust of the dryer 392 to the refrigerant by conduction through the evaporator coils 426 and plates. The cooling effect causes condensation of the moisture in air into water droplets, which drain out of the evaporator 422. The refrigerant now flows through the low pressure vapour insulated output into an accumulator positioned in the compressor room, to trap any liquid that did not boil in the evaporator 422. The accumulator 428 is positioned in the warm exhaust stream of the internal combustion engine 412, to assist in evaporation of liquid, Refrigerant then passes through a compressor pressure regulator 430, to prevent too high a pressure returning to the compressor in the event of overload. The refrigerant then returns to the intake of the compressor 410 where it is compressed back into a liquid of high pressure, causing a rise in temperature of the compressed liquid and release of thermal energy. The fluid is stored in a reservoir tank within the compressor 410 and then flows from the compressor 410 to the condenser 432, where another large surface area against the air flow is created. The combined heat from the compressor motor 412, the waste heat from the generator 418 and vacuum unit 318, the compressor 410, and the air heated by the condenser unit 432, will then flow into the dryer 392 through the air intake 420, shown in FIG. 11, by force of the air intake blower in the dryer 392. The refrigerant now flows to a receiver that is positioned in the cold air intake stream, as to facilitate sub-cooling and injecting more heat into the air intake. Refrigerant then returns to the thermal expansion valve to continue the cycle.

Referring to FIG. 13, an optional dehumidifier 434 may be used in conjunction with dryer 392. Dehumidifier has an evaporator 436 and a condenser 438 through which air can be passed to remove excess water.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method for removing seaweed from a beach, comprising:
providing a primary vessel with a seaweed collection area and a vacuum source;
anchoring the primary vessel offshore;
connecting one end of a vacuum hose to the vacuum source and extending a remote end of the vacuum hose to the beach;
controlling the positioning of the remote end of the vacuum hose along the beach with a secondary vessel that is small in relation to the primary vessel; and
activating the vacuum and feeding seaweed into the remote end of the vacuum hose, such that seaweed is drawn by the vacuum source through the vacuum hose to the seaweed collection area on the primary vessel.

2. The method of claim 1, including a step of washing the seaweed with salt water to remove contaminants before depositing the seaweed into the seaweed collection area, the salt water being drawn from the body of water that the primary vessel is floating upon.

3. The method of claim 1, including a step of removing water from the seaweed before depositing the seaweed in the seaweed collection area, the seaweed being dehydrated until the water content of the seaweed is within selected limits.

4. An apparatus for removing seaweed from a beach, comprising:
a primary vessel with a collection area;
a vacuum source positioned on the primary vessel configured to discharge into the collection area;
a vacuum hose having a first end connected to the vacuum and a remote end;
a secondary vessel that is small in relation to the primary vessel coupled to the vacuum hose to control the remote end of the vacuum hose; and
a seaweed receiver configured to be positioned on the beach and connected to the second end of the vacuum hose.

5. The Apparatus of claim 4, wherein the primary vessel has a seaweed conditioning area with a seaweed washer, the seaweed washer being configured to wash the seaweed using salt water drawn from a body of water that the primary vessel is floating upon.

6. The Apparatus of claim 4, wherein the primary vessel has a seaweed conditioning area with a seaweed dryer.

7. The Apparatus of claim 6, wherein the seaweed dryer uses waste heat from the vacuum source.

8. The Apparatus of claim 4, wherein the vacuum hose has a first length of hose of a first diameter which floats on water and a second length of hose of a relatively smaller second diameter.

9. The Apparatus of claim 5, wherein a first seaweed metering station receives seaweed from the vacuum and controls a flow of seaweed along a first conveyor to the seaweed washer.

10. The Apparatus of claim 6, wherein a second seaweed metering station receives seaweed from the seaweed washer and controls a flow of seaweed along a second conveyor to the seaweed dryer.

11. The apparatus of claim 4, wherein a sound barrier is provided to deflect sound from the vacuum source away from the beach.

12. An apparatus for removing seaweed from a beach, comprising:
a primary vessel with a collection area;
a vacuum source positioned on the primary vessel configured to discharge into the collection area;
a vacuum hose having a first end connected to the vacuum and a remote end;
a seaweed receiver configured to be positioned on the beach and connected to the second end of the vacuum hose;
a seaweed conditioning area with a seaweed washer, the seaweed washer being configured to wash the seaweed using salt water drawn from a body of water that the primary vessel is floating upon; and
a seaweed conditioning area with a seaweed dryer.
